(19) United States
(12) Patent Application Publication
(10) Pub. No.: US 2009/0204587 A1
(43) Pub. Date: Aug. 13, 2009

(54) METHOD FOR DETERMINING A DATA SET FOR DIAGNOSTIC USE FROM AMONG MULTIPLE STORED DATA SETS

(76) Inventors: Roland Faber, Uttenreuth (DE); Maria Kroell, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 12/366,754

(22) Filed: Feb. 6, 2009

(30) Foreign Application Priority Data
Feb. 7, 2008 (DE) 10 2008 007 824.7

(51) Int. Cl. G06F 17/30

(52) U.S. Cl. 707/3; 707/E17.014

(57) ABSTRACT

In a method to determine one or more data sets (in particular radiological data sets) generated at an earlier point in time—which data sets are to be considered in the framework of a medical diagnosis, which data sets contain text information generated in the framework of earlier evaluations—from a data set assemblage containing a number of different data sets stored in a computer, an input or selection field for a search term is presented to the user on a monitor, in which field the user inputs or selects at least one search term, after which the text information of all data sets is automatically analyzed. That data set or those data sets that contain the search term or a comparable term associated with this search term in their text information are identified and displayed.

### BACKGROUND OF THE INVENTION

1. Field of the Invention

The present invention concerns a method to determine one or more data sets (in particular radiological data sets) generated at an earlier point in time—which data sets are to be considered in the framework of a medical diagnosis, which data sets contain text information generated in the framework of earlier evaluations—from a data set assemblage containing a number of different data sets, which data sets are stored in a computer.

2. Description of the Prior Art

In the scope of an imaging examination in which diagnostically relevant images of a patient are acquired using one or more imaging modalities, and in the scope of the subsequent diagnosis, it is frequently necessary to consider not only a presently acquired image but also image data or general data sets acquired at an earlier point in time in order to make a complete image of a possible pathology of a patient, or in order to make a verification of a possible diagnosis in comparable cases. Such data sets generated at an earlier point in time have typically already been assessed, meaning that they have already been analyzed or diagnostically evaluated by a physician and provided with text information that describes the diagnosis or the analysis made at that earlier point in time. This means that (for example in the framework of the radiological finding) the diagnosis and the finding normally ensue on the basis of considerable data material, thus data sets from various sources (a finding generated in the framework of a prior examination and a subsequent referral, other different prior findings, current and older image and diagnosis data, laboratory results, etc.). Specific features within the text information are sought from different points in time in order to locate a comparable data set. This search ultimately ensues manually on the basis of the recall capability of the searcher. This means that the search is essentially conducted in a context-related manner for keywords that can be contained in the text information with regard to the respective data set. For example, the radiologist may have found a lesion of, for example, 3 cm in diameter in a current image exposure. It is now of interest for the radiologist as to whether and if/when such a lesion was already mentioned in possible prior findings of the patient, and if so what size the lesion had at that time. Conventionally, the radiologist must now search through all text information in the earlier data sets of the patient in order to obtain the desired information. Another example would be to conduct a search (for example by the radiologist) for a comparable finding of a different patient in order to evaluate the current diagnosis using the finding made at that earlier time.

This procedure is very complicated and time-consuming; moreover, it is error prone since sought text information in an older data set can very easily be overlooked.

### SUMMARY OF THE INVENTION

An object of the present invention is to provide a method with which the determination of one or more relevant data sets can ensue more quickly and without error.

To solve this problem, in a method of the aforementioned type it is provided according to the invention that an input or selection field for a search term is presented to the user on a monitor, in which field the user inputs or selects a search term, after which the text information of all data sets is automatically analyzed, and that data set or those data sets that contain the search term or a comparable term associated with this search term in their text information are determined and displayed.

In the method according to the invention, an automatic data set determination ensues on the part of the computer in which the data sets are stored. The computer is configured to display a corresponding input or selection field to the user on a monitor when the user has selected a data set search module via the monitor, for example. In this input or selection field, the user can now define a search term, either by a manual input of the search term via a keyboard, or by selecting the search term from a file that is selectively displayed to the user. After the definition of the search term, the computer now automatically analyzes whether the search term sought in its stored data sets is contained in the present text information. The computer can search not only for the presence of the identical search term but also is configured such that comparable terms (for example other possible spellings or synonyms associated with the search term, etc.) deviating from the search term can be found as matches. This means that both an identical term collection and the collection of alternative terms on the part of the computer are possible; ultimately a thesaurial analysis procedure is thus realized.

The computer now automatically detects all data sets that contain text information that the search or comparable term possesses and presents these data sets on the monitor in a form that is simple for the user to comprehend. The user can now separately select and assess the individual found data sets. Because this comparison ensues automatically on the part of the computer, a significantly faster data set determination inevitably results that moreover also ensues without error since—via the use of the computer in the framework of the automatic search—a programmatic search algorithm is resorted to that inevitably detects all actual, present text information to be determined. This means that the determination result is complete and free of error and presented to the physician within the shortest possible time, who can then either refine or check the finding he has presently made.

The search terms selectable via the input or selection field are advantageously comprised in a database that is displayed to the user in the input or selection field. This database is essentially a specialized dictionary that includes a prepared technical knowledge (possibly hierarchically sub-divided) and that is displayed to the user as a selection index in the corresponding field. Naturally only a portion of the search terms is respectively displayed in the field depending on how large the field is designed. Naturally, the user can select within the presented terms, for example scroll or limit the display to terms with a first letter via input of this first letter of the search term, etc. This means that the user can navigate within the presented search term database in all respects. One or more associated, comparable terms that are displayed (possibly selectively on the part of the user) can thereby also be stored in the prepared database for each search term. This means that one or more comparable terms are also associated with a specific search term, for example other possible spellings or synonyms etc. that are determined together with the search term in the framework of the automatic text information analysis. The user can have the stored comparable terms displayed (for example in that he selects the search term with a cursor) in order to get a picture of the automatically implemented search strategy. A search term with which one or more comparable terms are associated can, for example, be presented in a different color so that the user can recognize that additional associated terms are present in the background.

As an alternative to the input or selection directly in the or within the displayed input or selection field, it is also conceivable to make a speech input after selection of the automatic search mode and display of a corresponding input and selection field (for example also in the form of an input requirement). This means that the input of a search term via speech input is also to be understood by the term “input or selection of a search term in the input or selection field”.

Boundary conditions are sometimes provided (not least due to the possible diagnostic question) that inherently preclude the relevance of specific existing data sets. For example, this can be the gender of the current patient when comparison data sets are sought, or the patient name when only earlier data sets of this patient are sought. In order to avoid in such cases that all existing data sets are analyzed on the part of the computer in spite of the nonexistent relevance of a portion of the same, an advantageous development of the invention provides that at least one item of information limiting the data sets to be analyzed in the framework of the analysis can be input on the part of the user via the input or selection field or an additional input or selection field. Such an item of limiting information can be, for example, be the age of the patient or of the comparison patient whose earlier diagnosis is to be considered for comparison purposes, as well as the date of the data set creation of an earlier data set or the name of the treating physician, etc. The user inputs this limiting information via the already-displayed or possibly an additional displayed input or selection field, whereupon the computer makes a preliminary selection of the data sets that are to be analyzed at all, or searches only in these for the input search term.

Here as well a separate file can be provided in which selectable limiting information is comprised that is displayed to the user in the respective input or selection field. This means that here as well the user can select, within a predetermined assemblage of limiting information, that information that he or she specifically requires.

Given multiple determined data sets to be displayed the computer is fashioned to display these in a reproduction form that can be configured on the part of the user. The user has the possibility to select the form of the reproduction and, for example, to have them sorted according to the gender of the patient from whom the comparison data sets originate, according to the patient's age, etc. This means not only that an automatic data set determination ensues but that a data set reproduction configurable by the user is also possible. Here the possibility also exists to have the selectable configuration parameters comprised in a separate file displayed in the or an input and selection field within which the user can define the desired configuration.

In the framework of the presentation of the found data sets, a navigation aid can be provided to the user that directs him to the search term found in a data set. For example, this can ensue via a link associated with the data set that he can select, wherein after selection of the link the portion of the data set that contains the search term is automatically shown. It is also possible to optically emphasize the search term in the text, for example by underlining or by color highlighting. If the search result includes multiple data sets, the navigation aid can also mark the already-viewed data sets (for example highlight them in color) so that the user can immediately see which data sets he has already viewed (considered) and which he must still viewed. It is thereby ensured that no data set is overlooked.

### BRIEF DESCRIPTION OF THE DRAWINGS

FIG. 1 schematically illustrates a first embodiment of the method according to the present invention.

FIG. 2 schematically illustrates a second embodiment of the method according to the invention.

### DESCRIPTION OF THE PREFERRED EMBODIMENTS

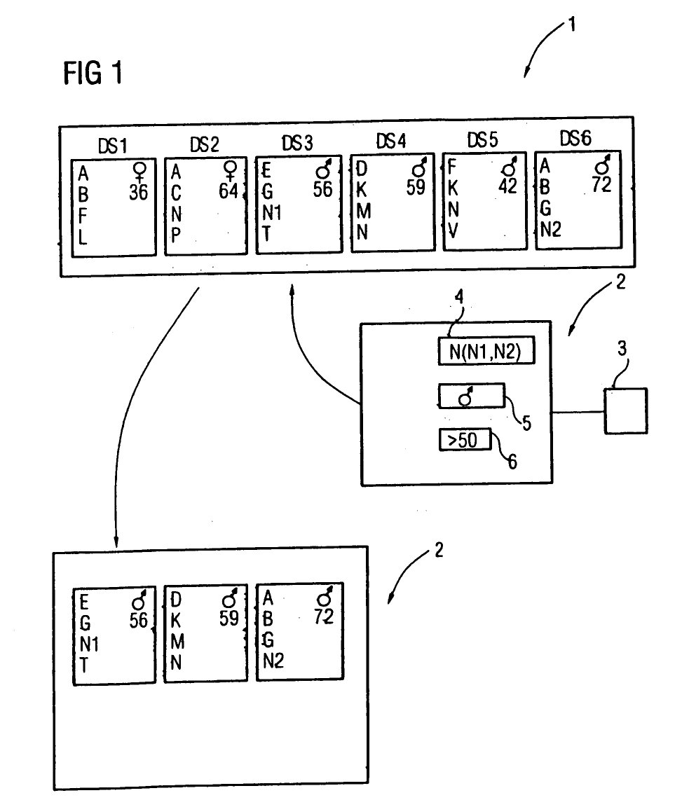

FIG. 1 shows (in a schematic representation) a computer 1 in which are stored a number of data sets, wherein here six data sets DS1-DS6 are shown as an example. The computer 1 is associated with a monitor 2 and an input unit 3 (for example a keyboard or a mouse) via which information can be input or defined on the monitor 2.

Each of the data sets DS1-DS6 in the exemplary embodiment shown in FIG. 1 contains text information comprising technical medical terms (indicated here with letters A, B, C, . . . ). For example, the data set DS1 thus contains the text information (technical terms) A, B, F and L, the data set DS2 contains the text information (technical terms) A, B, N, P etc.

The gender of the examined patient is also indicated for each data set, represented by the respective symbol ♂ (female) or, respectively, ♀ (male). The data sets DS1 and DS2 consequently belong to insides of patients while the data sets DS3-DS6 belong to patients. The respective age of the examined patient insides or of the examined patients also indicate that the patient from whom the data set DS1 originate was 36 years old at the point in time of the acquisition, the patient of data set DS2 was 64 years old, the patient of data set DS3 was 56 years old etc. Naturally, each data set contains an additional plurality of further information such as acquisition point in time etc. and naturally also the corresponding image data that the physician would like to assess after the implemented automatic search; however, this is not shown in detail for reasons of clarity.

If the user has previously selected a corresponding icon (“Text Information Search”), a first input field 4 is initially displayed on the monitor 2 to the user by the computer 1, which naturally possesses a suitable processor in additional implemented data processing software etc. In this input or selection field 4 the user can now either input a search term (here in the form of a technical medical term) manually via the input means 3 (keyboard) or select such a search term from a search term assemblage (comprised in a search term file) that is displayed to him in the input field 4.

In the shown example the user has selected the search term “N”. As is shown in field 4, two comparable terms N1 and N2 are associated with the search term N. In the framework of the subsequently described automatic data set analysis, the computer 1 consequently searches not only for the search term N but also for the comparable terms N1 and N2 which, for example, are other spellings or synonyms of the search term N.

An additional input or selection field 5 is also displayed to the user in which the user can input a first item of information limiting the data sets to be analyzed. In the shown example, he has here defined via the input means 3 that the search term N (in addition to the comparable terms N1 and N2) should only be searched for in data sets of male patients.

The possibility to input a second item of limiting information to limit the data sets to be analyzed exists in an additional input and selection field 6. Here the user has input an age specification, according to which only such data sets in which the patient was older than 50 years should be analyzed with regard to the search term or, respectively, the comparable terms. All information input in the input and selection fields 4, 5 and 6 are “and”-linked, which means that only those data sets are selected that exhibit all boundary conditions defined there.

If the search is now started, the computer 1 automatically analyzes the data sets via a suitable algorithm and detects those data sets that satisfy the desired criteria.

In the framework of the search strategy, the search is initially conducted according to the limiting data set boundary conditions of the input or selection fields 5 and 6. Only the data sets DS3, DS4 and DS6 are associated with male patients that are older than 50 years. Although the patient of data set DS5 is male, at 42 years old he is younger than the defined boundary condition.

The search is then conducted for the search term and the comparable terms according to the input and output field 4. The search term N is located in the data set DS4, which is consequently to be selected. N1 is found in data set DS3 while N2 is found in data set DS6. As a result of this these three data sets are output on the monitor 2 as an analysis result, as shown below in FIG. 1. Although the data set DS6 also possesses the search term “N”, this data set is not considered since the patient is younger than 50 years of age.

The determined data sets are now output to the user (possibly in a manner that he can configure), as is shown by way of example in FIG. 1. The physician can now individually select these data sets (which naturally are not specified with technical terms etc. but rather are indicated only as corresponding data set files) and can consider all of those that possess the search term he has sought or comparable terms, or the associated images for the subsequent diagnosis.

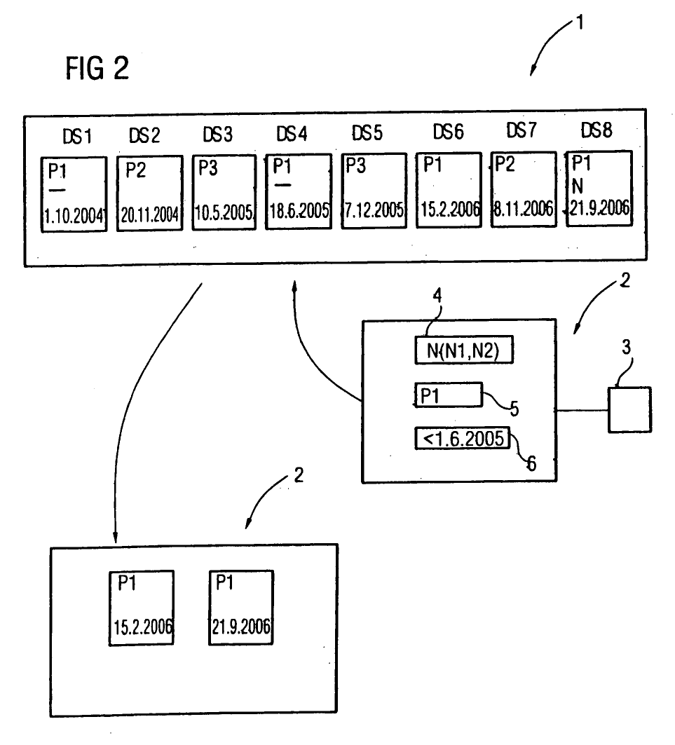

FIG. 2 in turn shows the computer 1, here containing a plurality of individual data sets acquired at an earlier point in time, wherein here eight data sets DS1-DS8 are indicated by way of example. The respective name of three of the patients is specified for each data set, symbolized by P1, P2 and P3. The point in time of the data set creation is also specified for each data set. The data set DS1 originates from a person P1 and was acquired on 1 Oct. 2004; the data set DS2 originates from a person P2 and was acquired on 20 Nov. 2004; the data set DS3 originates from a person P3 and was acquired on 10 May 2005 etc.

Here various input or selection fields 4, 5, 6 are also displayed to the user on the monitor 2. In the input or selection field 4, the user here has selected (again via the input means 3) the search term, symbolized by N in addition to the comparable terms N1 and N2.

In the input or selection field 5, he has defined the person P1 as a person from whom he would like to assess relevant data sets, ultimately thus has defined the name of the sought person. In the input and selection field 6 the user has also defined that he or she would like to analyze only those data sets that were acquired after the 1 Jun. 2005. Here the input and selection fields 4, 5 and 6 are also “and”-linked.

In the present case, of the eight data sets the data sets DS1, DS4, DS6 and DS8 are associated with the sought person P1. Within these data sets, only the data sets DS4, DS6 and DS8 originate from a time period after 1 Jun. 2005, which means that the computer will search for the search term N or, respectively, the comparable terms N1 and N2 only within these. From this assemblage, only the data sets DS6 and DS8 in turn contain the search term N; the data set DS4 contains no entry for this, as is represented by the “-” symbol. This means that (as is shown below in FIG. 2) only the two data sets DS6 and DS8 are output on the monitor 2 to the user, who can now select these data sets for closer assessment and can have the underlying image data displayed.

As a whole, the method according to the invention enables relevant data sets that were acquired at an earlier point in time to be determined significantly more quickly in the framework of an imaging diagnosis, which data sets are also always assessed for whatever reasons in the framework of a current finding. The quality of the finding can thereby be improved because relevant facts from earlier findings can be assuredly detected and cannot be overlooked.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for determining at least one radiological data sets from among a plurality of radiological data sets generated and stored as a result of earlier, respective diagnostic evaluations of the radiological data sets, each of the stored radiological data sets comprising text information, comprising the steps of:
for implementing a current medical diagnosis, displaying an input field or a selection field for a search term to a user at a monitor of a computer having access to the stored radiological data sets;
entering, via said input field or selection field, at least one search term;
after entry of said search term, automatically implementing computerized searching of said text information of all of the stored radiological data sets; and
from said searching, identifying any stored radiological data sets comprising text information that contains the search term, as search results, and displaying the search results at said monitor.

2. A method as claimed in claim 1 comprising storing selectable search terms in a data base, and displaying said selectable search terms to the user at said monitor in said input field or selection field.

3. A method as claimed in claim 2 comprising storing at least one associated comparable term with each of said selectable search terms in said data base.

4. A method as claimed in claim 1 comprising allowing entry at said monitor of at least one item of information limiting a number of said stored radiological data sets to be analyzed in the searching.

5. A method as claimed in claim 4 comprising displaying said at least one item of information in said input field or selection field.

6. A method as claimed in claim 1 comprising displaying said search results in a form at said monitor that is configurable by said user.

7. A method as claimed in claim 6 comprising presenting said user with selectable configuration parameters in said input field or selection field at said monitor.
